(19) United States
(12) Patent Application Publication
(10) Pub. No.: US 2007/0274006 A1
(43) Pub. Date: Nov. 29, 2007

(54) Method of reworking magnetic head assembly in which electrode pad of magnetic head slider and electrode pad of suspension are soldered to each other

(75) Inventors: Ooki Yamaguchi, Niigata-ken (JP); Takao Haino, Niigata-ken (JP); Hideaki Abe, Niigata-ken (JP); Hiroyuki Sekiguchi, Niigata-ken (JP); Haruo Kurai, Niigata-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Alps Electric Co., Ltd., Ota-ku (JP)

(21) Appl. No.: 11/802,020

(22) Filed: May 18, 2007

(30) Foreign Application Priority Data
May 19, 2006 (JP) 2006-139897
May 19, 2006 (JP) 2006-139898

(51) Int. Cl. G11B 5/55

(52) U.S. Cl. 360/264

(57) ABSTRACT

Exemplary embodiments of the invention provide a method of reworking a magnetic head assembly in which an electrode pad of a magnetic head slider and an electrode pad of a suspension are soldered so as to be perpendicular to each other and in which a defective slider is replaced with a new slider when the magnetic head slider is the defective slider. The method includes planarizing a solder, which bonds the electrode pad of the defective slider and the electrode pad of the suspension, on the electrode pad of the suspension by a hot wind and reusing the planarized solder to bond the electrode pad of the new slider replaced for the defective slider and the electrode pad of the suspension to each other.

This application claims the benefit of Japanese Patent Application No. 2006-139897, filed May 19, 2006 and Japanese Patent Application No. 2006-139898, filed May 19, 2006, the contents of which are hereby incorporated by reference.

### BACKGROUND OF THE INVENTION

1. Field of the Invention

The present invention relates to a method of reworking a magnetic head assembly in which an electrode pad of a magnetic head slider and an electrode pad of a suspension are soldered so as to be perpendicular to each other.

2. Description of the Related Art

A magnetic head assembly used in a hard disk drive (HDD) includes a magnetic head slider having a magnetic head and a suspension to which the magnetic head slider is attached and fixed. The suspension has a flexture elastically supporting the magnetic head slider, and a flexible wiring board for electrically connecting an external circuit to the magnetic head is attached to a surface of the flexture. The electrode pad of the magnetic head slider and the electrode of the suspension (flexible wiring board) are connected to each other by a solder ball bonding using a solder ball which can be formed with a caliber smaller than that of a gold ball so that a bonding area (a size of a electrode pad and a gap between electrode pads) becomes narrow.

In this kind of magnetic head assembly, a dynamic characteristic inspection is performed before shipment. The dynamic characteristic inspection is to inspect electrical characteristics in a state where the magnetic head slider is attached to the suspension, is mounted to a spin stand, and the hard disk is practically rotated. In general, the dynamic characteristic inspection has been a final characteristic inspection which determines whether a good or defective magnetic head slider. In this dynamic characteristic inspection, when the dynamic characteristics as the inspection result satisfy a standard, the magnetic head slider is determined as a good slider and the magnetic head assembly becomes a product. Meanwhile, when the dynamic characteristic does not satisfy the standard, the magnetic head slider is determined as a defective slider and is removed from the suspension. The suspension after removing the slider is reused. When the defective slider is removed from the suspension, the solder bonding between the electrode pad of the defective slider and the electrode pad of the suspension is released, a bonding strength between the defective slider and the suspension is weaken, and then the defective slider is removed by force.

Japanese Unexamined Patent Application Publication No. 2002-367132 (Japanese Examined Patent Application Publication No. 3634773) (US Pub. No. 2002186509 A1 (U.S. Pat. No. 6,971,155 B2)) is disclosed as an example.

However, when the defective slider is removed from the suspension by the conventional method, the solder which bonds the electrode pad of the defective slider and the electrode pad of the suspension remains on the electrode pad of the suspension, whereby a burr occurs. When this burr is located on a slider mounting surface of the suspension, an electrode pad of a new slider replaced for the defective slider comes in contact with the burr in the course of mounting the new slider, and thus it is difficult to appropriately mount the new slider. In this case, the suspension cannot be reused. In order to remove the burr on the electrode pad of the suspension, a molten solder is completely absorbed at the time of releasing the solder bonding between the electrode pad of the defective slider and the electrode pad of the suspension. However, high-cost equipments are required in the work for absorbing the solder. Accordingly, it is difficult to reuse the suspension by simple reworks and equipments.

### SUMMARY OF THE INVENTION

The invention has been made to provide a method of reworking a magnetic head assembly capable of reusing a suspension by removing a burr which disturbs mounting a slider.

Exemplary embodiments of the invention planarize a solder bonding an electrode pad of a defective slider and an electrode pad of a suspension so as not to disturb rework of the suspension, and further, so as to reuse the solder at the time of the reworks of the suspension.

According to exemplary embodiments of the invention, a method of reworking a magnetic head assembly in which an electrode pad of a magnetic head slider and an electrode pad of a suspension are soldered so as to be perpendicular to each other and in which a defective slider is replaced with a new slider when the magnetic head slider is the defective slider is provided. The method includes planarizing a solder, which bonds the electrode pad of the defective slider and the electrode pad of the suspension, on the electrode pad of the suspension by a hot wind and the step of reusing the planarized solder to bond the electrode pad of the new slider replaced for the defective slider and the electrode pad of the suspension to each other.

The defective slider may be removed from the suspension before the solder planarizing process. In addition, the defective slider may be removed together with a part of the solder which bonds the electrode pad of the defective slider and the electrode pad of the suspension.

In the suspension, an opening portion may be provided between the slider mounting surface and the electrode pad. In this embodiment, the solder may be planarized on the electrode pad of the suspension by blowing a hot wind from the upside of the electrode pad of the suspension toward the opening portion. A part of the solder planarized on the electrode pad of the suspension by the wind pressure of the hot wind is relieved to the opening portion, whereby the planarization becomes easy.

A solder ball may be supplied between the electrode pad of the new slider and the planarized solder, and the electrode pad of the new slider and the electrode pad of the suspension may be bonded by melting the solder ball. Solder wettability is improved due to the planarized solder, whereby the electrode pad of the new slider and the electrode pad of the suspension is easily soldered.

Exemplary embodiments of the invention planarize a solder bonding an electrode pad of a defective slider and an electrode pad of a suspension so as not to disturb rework of the suspension, and further, so as to reuse the solder at the time of the reworks of the suspension. Particularly, in order to prevent the slider mounting surface of the suspension from the molten solder scattered in the course of planarization, the solder may be planarized with the defective slider remaining.

According to embodiments of the invention, there is provided a method of reworking a magnetic head assembly in which an electrode pad of a magnetic head slider and an electrode pad of a suspension are soldered so as to be perpendicular to each other and in which a defective slider is replaced with a new slider when the magnetic head slider is the defective slider is provided. The method comprising the steps of forming a planarized solder on the electrode pad of the suspension by heating a solder, which bonds the electrode pad of the defective slider and the electrode pad of the suspension to each other, by a hot wind with the defective slider remaining on the suspension, removing the defective slider from the suspension, mounting a new slider replaced for the defective slider on the suspension, and reusing the planarized solder to bond the electrode pad of the new slider and the electrode pad of the suspension to each other.

While forming the planarized solder, a surface opposite to the slider mounting surface of the suspension may be heated at a temperature lower than that of the hot wind at the same time of heating by the hot wind.

An opening portion may be provided between a slider mounting surface of the suspension and the electrode pad of the suspension. In this embodiment, the solder may be planarized on the electrode pad of the suspension by blowing a hot wind from the upside of the electrode pad of the suspension toward the opening portion. A part of the solder planarized on the electrode pad of the suspension by the wind pressure of the hot wind is relieved toward the opening portion, whereby the planarization becomes easy.

A solder ball may be supplied between the electrode pad of the new slider and the planarized solder, and the electrode pad of the new slider and the electrode pad of the suspension may be bonded by melting the solder ball. Solder wettability is improved due to the planarized solder, whereby the electrode pad of the new slider and the electrode pad of the suspension is easily soldered.

According to embodiments of the invention, since the solder which bonds the electrode pad of the defective slider and the electrode pad of the suspension is planarized on the electrode pad of the suspension, the burr which disturbs the mounting of the slider does not occur and the suspension can be reused.

### BRIEF DESCRIPTION OF THE DRAWINGS

FIG. 1 is a plan view that illustrates an entire structure of a magnetic head assembly (completed state) for a hard disk drive to which a method of the invention is applied.

FIG. 2 is a sectional view that illustrates a solder bonding portion between an electrode pad of the magnetic head slider in FIG. 1 and an electrode pad of a suspension.

FIG. 3 is a sectional view that illustrates a process according to the invention.

FIG. 4 is a sectional view that illustrates a process next the process shown in FIG. 3.

FIG. 5 is a sectional view that illustrates a process next the process shown in FIG. 4.

FIG. 6 is a sectional view that illustrates a planarized solder formed by the process shown in FIG. 5.

FIG. 7 is an enlarged sectional view of FIG. 6.

FIG. 8 is a schematic plan view that illustrates a planarized solder formed by the process shown in FIG. 5 or FIG. 13.

FIG. 9 is a sectional view that illustrates a process next the process shown in FIG. 5 or FIG. 13.

FIG. 10 is a sectional view that illustrates a process according to the invention.

FIG. 11 is a sectional view that illustrates a planarized solder formed by the process shown in FIG. 10.

FIG. 12 is a sectional view that illustrates a process next the process shown in FIG. 10.

FIG. 13 is a sectional view that illustrates a process next the process shown in FIG. 12.

### DETAILED DESCRIPTION

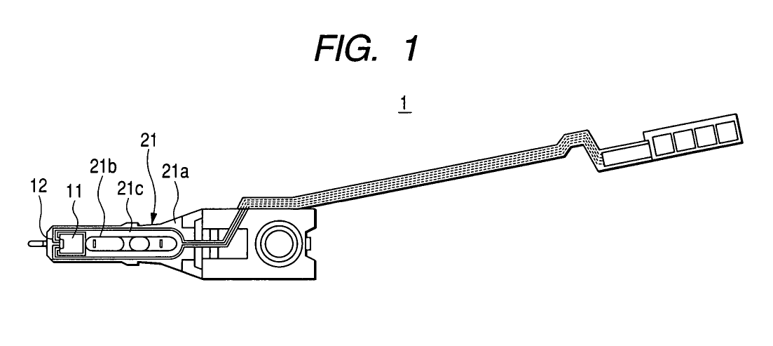

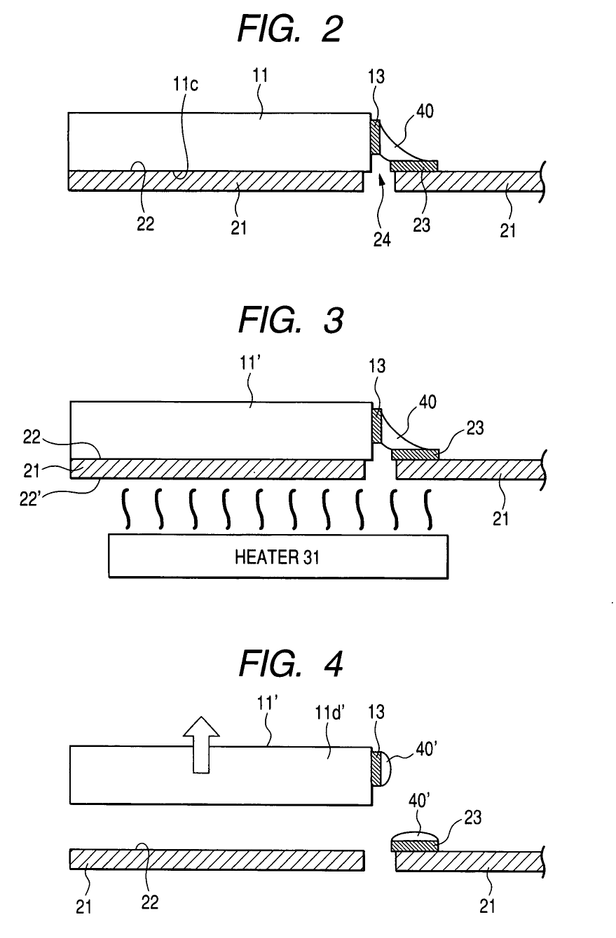

FIG. 1 is a plan view that illustrates an entire structure of a magnetic head assembly (completed state) for a hard disk drive to which a method of the invention is applied. The magnetic head assembly 1 includes a magnetic head slider 11 having a magnetic head 12 and a suspension 21 bonding and fixing the magnetic head slider 11. The suspension 21 has a load beam 21a and a flexture 21b mounted so as to elastically suspend and support the magnetic head slider 11 to the load beam 21a in a front end portion of the load beam 21a. The flexture 21b is a thin metal plate having a flexibility, which has a shape of a leaf spring. A flexible wiring board 21c for conductively connecting the magnetic head and an external circuit (circuit system of a hard disk device having the magnetic head assembly) is attached on a surface of the flexture by adhesive. In the magnetic head slider 11, as shown in FIG. 2, a back surface 11c thereof is adhered and fixed to a slider mounting surface 22 of the suspension 21 by a thermosetting adhesive and a plurality of electrode pads exposed to a trailing surface are bonded a plurality of electrode pads corresponding to the suspension 21, respectively. FIG. 2 is a sectional view that illustrates a solder bonding portion between an electrode pad 13 of the magnetic head slider 11 and an electrode pad 23 of a suspension 21. An opening portion 24 is formed between the slider mounting surface 22 of the suspension 21 and the plurality of electrode pads 23. The plurality of electrode pads 23 are disposed in a line toward the opening portion 24. Reference Numeral 40 in FIG. 2 denotes a solder (solder fillet) boding the electrode pad 13 of the magnetic head slider 11 and the electrode pad 23 of the suspension 21. The electrode pad 13 of the magnetic head slider 11 and the electrode pad 23 of the suspension 21 of a first embodiment are formed of Au.

The magnetic head assembly 1 becomes a product when it is judged as a good item in a dynamic characteristic inspection performed in a state where a hard disk is practically rotated. However, when it is judged as a defective item, the magnetic head slider 11′ (hereinafter, referred to as a defective slider) with the defective characteristic is removed from the suspension 21 and a reworking for reusing the suspension 21 is performed.

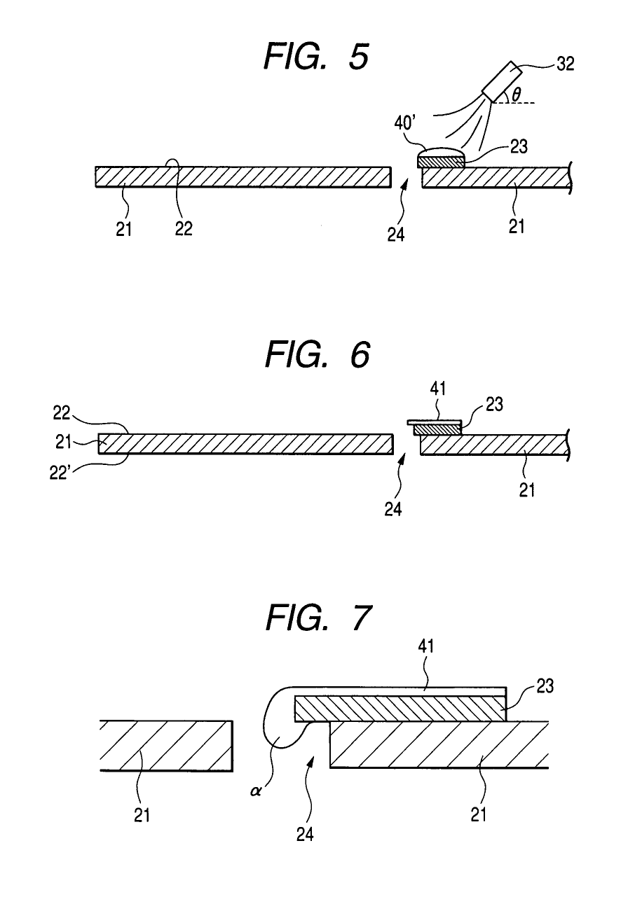

A first embodiment of the rewording method according to the invention is described with reference to FIGS. 3 to 9. FIGS. 3 to 5 and FIG. 9 are sectional views that illustrates processes of the reworking method according to the invention and FIGS. 6 to 8 are sectional views and a schematic plan view illustrating a planarized solder formed by the process in FIG. 5.

When the magnetic head slider 11 is judged as the defective slider 11′ in the dynamic characteristic inspection, the suspension 21 is heated by a heater 31 as shown in FIG. 3. The heater 31 is disposed so as to face a back surface 22′ opposite to the slider mounting surface 22 of the suspension and heats the suspension 21 from the back surface 22′. The heating temperature may be approximately in the range of 250 to 300° C. Due to the heating, the bonding strength between the defective slider 11′ and the suspension 21 weakens and the solder 40 bonding the electrode pad 13 of the defective slider 11′ and the electrode pad 23 of the suspension 21 softens. In this state, as shown in FIG. 4, the defective slider 11′ is lifted up on holding both sides of the defective slider 11′. Thus, the solder 40 is separated into a slider side and a suspension side and the defective slider 11′ is detached together with a part 40′ of the solder 40 from the suspension 21. The detached defective slider 11′ is destroyed.

After the defective slider 11′ is removed, the slider mounting surface 22 of the suspension 21 is exposed and the separated solders 40′ remain on the plurality of electrode pads 23.

As shown in FIG. 5, the solder 40′ is planarized on the electrode pad 23 by blowing a hot wind from the upside of the electrode pad 23 of the suspension 21 toward the opening portion 24 (direction from upside to downside in FIG. 5). Herein, the planarization means that macroscopic unevenness does not exist and the solder 40′ has a thickness smaller than 10 μm. Specifically, a hot air gun 32 is used as a hot-wind supplying source in the first embodiment. A nozzle of the hot air gun 32 is disposed so as to be inclined to the surface of the electrode pad 23 of the suspension 21 at an angle θ. In an exemplary embodiment angle θ may be approximately 45°. The hot air gun 32 blows a hot wind of about 250° C. at a flow rate of 3 L/min. The solder 40′ on the electrode pad 23 is molten by the hot wind, is bonded to the electrode pad 23 in a state where the molten solder 40′ comes in contact with the surface of the electrode pad 23 by pressure of the hot wind, and thus becomes a planarized solder 41 shown in FIGS. 6 to 8. The planarized solder 41 as a solder contact surface is reused when the electrode pad of the new slider and the electrode pad 23 are bonded. A thickness of the planarized solder 41 is about 0.5 μm. When the molten solder is planarized on the electrode pad 23 of the suspension 21, a part of the molten solder is relieved to opening portion 24 of the suspension 21 and thus becomes burr α. However, the burr α, as shown in FIG. 7, is downward. Accordingly, when the new slider is mounted on the suspension, the burr does not come in contact with the new slider and the electrode and does not disturb the mounting of the new slider.

The suspension 21 is reused as a reworking item after the planarized solder 41 is formed. As shown in FIG. 9, the new magnetic head slider (new slider) 11 is adhered and fixed on the slider mounting surface 22 of the suspension 21 by a thermosetting adhesive and the like. Then, the solder ball 42 is supplied between the electrode pad 13 of the new slider 11 and the planarized solder 41 of the suspension 21. Since the planarized solder 41 is planarized without macroscopic unevenness, the solder ball 42 is easily supplied and positioned. Since the electrode pad 13 the new slider 11 and the electrode pad 23 of the suspension 21 are bonded by completely melting the solder ball 42, the magnetic head assembly 1 is provided.

In Table 1, the result measuring a surface roughness Ra1 (nm) of the planarized solder 41 and a surface roughness Ra2 (nm) of an Au electrode pad by an AFM (Atomic Force Microscope) is shown. The surface roughness has been measured by the AFM at any 20 points of micro areas (10 μm×10 μm) corresponding to an area where the solder ball 42 comes in point-contact with the solder contact surface of the electrode pad 23 of the suspension 21. The electrode pad 13 of the magnetic head slider 11 and electrode pad 23 of the suspension 21 in the first embodiment are an Au electrode pad. The surface roughness of the electrode pad 23 of the suspension 21 in case of the new item (before assembly) is equivalent to the surface roughness Ra2 of the Au electrode pad shown in Table 1.

TABLE 1

| SURFACE ROUGHNESS | Ra1 | Ra2 |
|---|---|---|
| MINIMUM VALUE | 33.949 | 60.81 |
| MAXIMUM VALUE | 238.59 | 104.52 |
| AVERAGE VALUE | 92.03125 | 86.308 |
| RANGE | 204.641 | 43.71 |

As shown in the measured result of Table 1, the surface roughness Ra1 (average value) in the micro area of the planarized solder 41 is equivalent to the surface roughness Ra2 (average value) of the Au electrode pad. That is, in case of the new item (before assembly) and the reused item (after rework), the surface roughness of the solder contact surface (solder-ball supply surface) of the electrode pad 23 of the suspension 21 almost does not vary. Since the surface roughness is equivalent to each other, a method transferring a heat on the solder contact surface of the electrode pad 23 of the suspension 21 may be equivalent to each other. Accordingly, in case of the suspension 21 of the rework item (the planarized solder 41 is formed on the electrode pad 23), it is possible that electrode pad 23 of the suspension 21 and the electrode pad 13 of the magnetic head slider 11 are reliably soldered as well as the suspension 21 of the new item.

In the first embodiment, since the solder 40 bonding the electrode pad 13 of the defective slider 11′ and the electrode pad 23 of the suspension 21 is planarized on the electrode pad 23 of the suspension 21, the burr does not occur on the electrode pad 23 of the suspension 21 and thus the new slider 11 can be appropriately mounted on the suspension 21. In addition, it is not disturbed that the electrode pad 13 of the new slider 11 and the electrode pad 23 of the suspension 21 are soldered. Accordingly, it is unnecessary that the solder 40 be removed. Further, in the first embodiment, since the planarized solder 41 formed by planarizing the solder 40 on the electrode pad 23 of the suspension 21 is reused at the time of boding the electrode pad 13 of the new slider 11 and the electrode pad 23 of the suspension 21, a solder wettability is improved so as to easily solder both electrode pads 13, 23. Accordingly, since the suspension 21 can be effectively reused, yields are improved.

In the first embodiment, the defective slider 11′ is removed before the planarizing process in which the solder 40 bonding the electrode pad 13 of the defective slider 11′ and the electrode pad 23 of the suspension 21 is planarized on the electrode pad 23. However, the sequence of the solder planarizing process and the process removing the defective slider 11′ may be changeable.

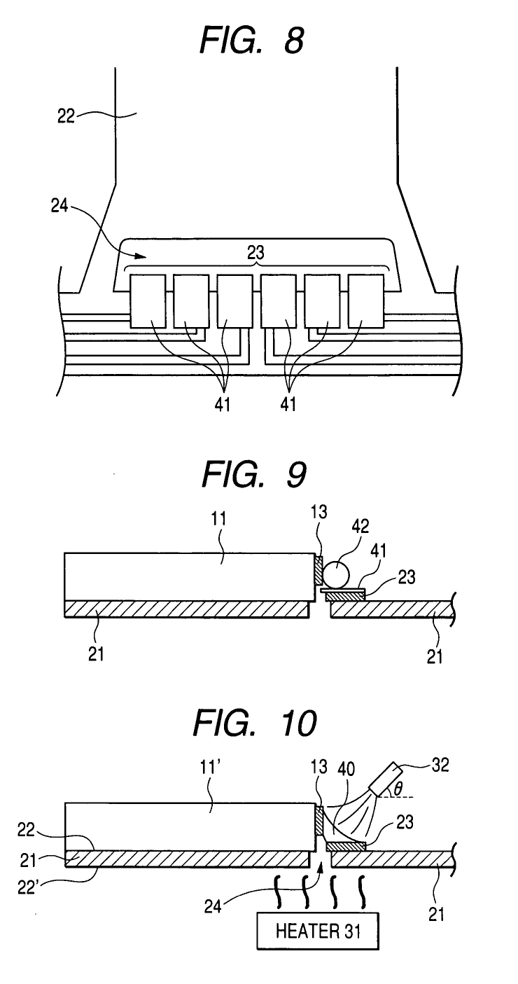

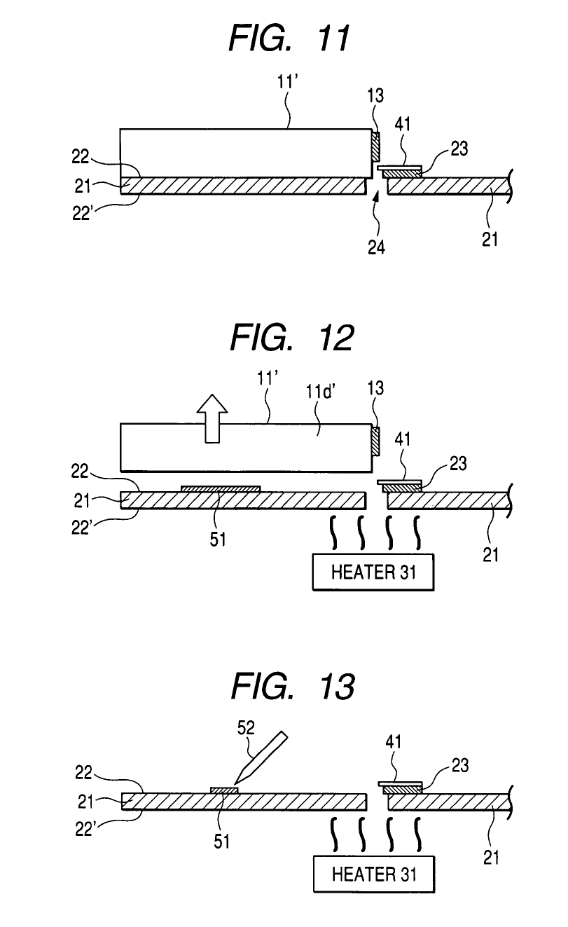

A second embodiment of the reworking method according to the invention is described with reference to FIGS. 10 to 13 and FIGS. 8 and 9. FIGS. 10, 12, 13, and 9 are sectional views that illustrate each process of the reworking method according to the invention. FIG. 11 is a sectional view illustrating a planarized solder formed by the process of the FIG. 10. FIG. 8 is a schematic plan view illustrating a suspension 21 after removing the slider.

When the magnetic head slider 11 is judged as the defective slider 11′ in the dynamic characteristic inspection, as shown in FIG. 10, the solder 40 which bonds the electrode pad 13 of the magnetic slider 11 and the electrode pad 23 of the suspension 21 is heated by the hot wind while the suspension 21 is heated by a heater 31 from the back surface 22′ opposite to the slider mounting surface 22 in a state where the defective slider 11′ remains on the slider mounting surface 22 of the suspension 21. The purpose of heating the suspension 21 by the heater 31 at the same time of the heating by the hot wind is to improve the wettability of the solder by decreasing the surface tension of the solder. The heating temperature by the heater 31 is higher than the melting point of the solder 40, specifically, about 250° C.

The hot wind is blown from the upside of the electrode pad 23 of the suspension 21 toward the opening portion 24 (from right upside toward the left downside in FIG. 10). Specifically, a hot air gun 32 is used as a hot-wind supplying source in the second embodiment. A nozzle of the hot air gun 32 is disposed so as to be inclined to the surface of the electrode pad 23 of the suspension 21 at an angle θ. In an exemplary embodiment angle θ may be approximately 45°. The hot air gun 32 blows a hot wind of about 250° C. at a flow rate of 3 L/min. The solder 40 is molten by the hot wind so that the bonding between the electrode pad 13 of the defective slider 11′ and the electrode pad 23 of the suspension 21 is released. A part of the molten solder 40 is scattered toward the slider mounting surface 22 of the suspension 21 by the wind pressure of the hot wind and the other part is oppressed on the surface of the electrode pad 23 by the wind pressure of the hot wind, whereby the molten solder is planarized on the electrode pad 23 of the suspension 21. Herein, the planarization that macroscopic unevenness does not exist and the solder 40 has a thickness smaller than 10 μm.

The scattering solder 40 toward the slider mounting surface 22 is attached to the defective slider 11′ on the slider mounting surface 22 and is not attached to the slider mounting surface 22. The defective slider 11′ is used as a member preventing the slider mounting surface 22 from the molten solder scattered by the hot wind. Meanwhile, the solder planarized on the electrode pad 23 of the suspension 21 becomes the planarized solder 41 as shown in FIG. 11. The planarized solder 41 becomes the solder contact surface of the electrode pad 23 of the suspension 21 and reused at the time of bonding the electrode pad of the new slider and electrode pad of the suspension. A thickness of the planarized solder 41 is about 0.5 μm.

As described above, when the solder 40 is planarized on the electrode pad 23 of the suspension 21, the molten solder on the electrode pad 23 of the suspension 21 may be extruded toward the slider mounting surface 22 by the hot wind. The solder extruded toward the slider mounting surface becomes the burr. However, the defective slider 11′ on the slider mounting surface 22 functions as a mechanical stopper. In the worst case, the burr occurs only at a position which comes in contact with the defective slider 11′. The burr, which is not shown in detail, is relieved to the opening portion 24 of the suspension 21 and is downward. Accordingly, when the new slider is mounted, the new slider and the burr of the solder on the electrode pad do not come in contact with each other and does not disturb the mounting of the new slider.

Next, as shown in FIG. 12, the defective slider 11′ is removed by heating the suspension 21 from the back surface 22′ opposite to the slider mounting surface 22 by the heater 31. The heating temperature of the heater 31 is about 100° C. The defective slider 11′ is easily detached from the suspension 21, for example, when the defective slider 11′ is lift up on holding both side surfaces 11d′ of the defective slider 11′ in a state where a bonding strength (bonding strength of the thermosetting adhesive which bonds the defective slider 11′ and the suspension 21) between the defective slider 11′ and the suspension 21 is weakened by this heating. At this time, the solder attached to the defective slider 11′ in the before-process (solder planarizing process) is also removed together with the defective slider 11′. The detached defective slider 11′ is destroyed. The thermosetting adhesive 51 which bonds the defective slider 11′ and the suspension 21 remains on the slider mounting surface 22 after removing the defective slider 11′.

As shown in FIG. 13, the thermosetting adhesive 51 remaining on the slider mounting surface 22 is removed by an adhesive removal tool 52 in a state where the suspension 21 is heated from the back surface 22′ opposite to the slider mounting surface 22 by the heater 31. The thermosetting adhesive 51 of the second embodiment is a resin. ULTEM resin bar, PEEK resin, or polyimide resin is used for the resin removal tool 52.

By the above processes, the slider mounting surface 22 equivalent to the new item is exposed and a suspension 21 having the planarized solder 41 on the electrode pad 23 is provided as shown in FIG. 8. This suspension 21 is reused as a rework item. That is, as shown in FIG. 9, a new magnetic head slider (new slider) 11 is bonded on the slider mounting surface 22 of the suspension 21, for example, by a thermosetting adhesive. Further, a solder ball 42 is supplied between the electrode pad 13 of the new slider 11 and the planarized solder 41 of the suspension 31. Herein, since the planarized solder 41 is planarized without a macroscopic unevenness, the solder ball 42 is easily supplied and positioned. The electrode pad 13 of the new slider 11 and the electrode pad 23 of the suspension 21 by completely melting the solder ball 42, whereby the magnetic head assembly 1 is provided.

In Table 2, the result measuring a surface roughness Ra1 (nm) of the planarized solder 41 and a surface roughness Ra2 (nm) of an Au electrode pad by an AFM (Atomic Force Microscope) is shown. The surface roughness has been measured by the AFM at any 20 points of micro areas (10 μm×10 μm) corresponding to an area where the solder ball 42 comes in point-contact with the solder contact surface of the electrode pad 23 of the suspension 21. The electrode pad 13 of the magnetic head slider 11 and electrode pad 23 of the suspension 21 in the second embodiment are an Au electrode pad. The surface roughness of the electrode pad 23 of the suspension 21 in case of the new item (before assembly) is equivalent to the surface roughness Ra2 of the Au electrode pad shown in Table 1.

TABLE 2

| SURFACE ROUGHNESS | Ra1 | Ra2 |
|---|---|---|
| MINIMUM VALUE | 35.12 | 60.81 |
| MAXIMUM VALUE | 108.59 | 104.52 |
| AVERAGE VALUE | 94.04 | 86.308 |
| RANGE | 73.47 | 43.71 |

As shown in the measured result of Table 2, the surface roughness Ra1 (average value) in the micro area of the planarized solder 41 is equivalent to the surface roughness Ra2 (average value) of the Au electrode pad. That is, in case of the new item (before assembly) and the reused item (after rework), the surface roughness of the solder contact surface (solder-ball supply surface) of the electrode pad 23 of the suspension 21 almost does not vary. Since the surface roughness is equivalent to each other, a method transferring a heat on the solder contact surface of the electrode pad 23 of the suspension 21 may be equivalent to each other. Accordingly, in case of the suspension 21 of the rework item (the planarized solder 41 is formed on the electrode pad 23), it is possible that electrode pad 23 of the suspension 21 and the electrode pad 13 of the magnetic head slider 11 are reliably soldered as well as the suspension 21 of the new item.

In the second embodiment, since the solder 40 bonding the electrode pad 13 of the defective slider 11′ and the electrode pad 23 of the suspension 21 is planarized on the electrode pad 23 of the suspension 21 with the defective slider 11′ remaining on the suspension 21, the burr does not occur on the electrode pad 23 of the suspension 21. Further, the solder burr formed by extruding the solder on the electrode pad 23 of the suspension 21 toward the slider mounting surface 22 stops at the position of the defective slider 11′. The burr which disturbs mounting the new slider 11 does not occur. Accordingly, the new slider 11 is appropriately mounted on the suspension 21, and the electrode pad 13 of the new slider 11 and the electrode pad 23 of the suspension 21 can be reliably soldered. In addition, since the defective slider remains at the time of planarizing the solder 40, the slider mounting surface 22 is prevented by the defective slider 11′ from the molten solder scattered by the hot wind. Accordingly, it is unnecessary that the solder 40 is removed by the absorbing work and the high-cost equipments are unnecessary. Further, in the second embodiment, since the planarized solder 41 formed by planarizing the solder 40 on the electrode pad 23 of the suspension 21 is reused at the time of boding the electrode pad 13 of the new slider 11 and the electrode pad 23 of the suspension 21, a solder wettability is improved so as to easily solder both electrode pads 13, 23. Accordingly, since the suspension 21 can be effectively reused, yields are improved.

In the second embodiment, it is used the solder burr in which the solder extruded from the electrode pad 23 of the suspension 21 toward the slider mounting surface 22 is relieved so as to be downward by the opening portion 24 of the suspension 21. However, since the solder burr, as described above, occurs only at the position of the defective slider 11′, the invention can be applied to a suspension not having the opening portion between the mounting surface and the electrode pad.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of reworking a magnetic head assembly in which an electrode pad of a magnetic head slider and an electrode pad of a suspension are soldered so as to be perpendicular to each other and in which a defective slider is replaced with a new slider when the magnetic head slider is the defective slider, the method comprising the steps of:
planarizing a solder, which bonds the electrode pad of the defective slider and the electrode pad of the suspension, on the electrode pad of the suspension by a hot wind; and
reusing the planarized solder to bond the electrode pad of the new slider replaced for the defective slider and the electrode pad of the suspension to each other.

2. The method according to claim 1, further comprising removing the defective slider from the suspension before planarizing the solder.

3. The method according to claim 2, wherein the defective slider is removed together with a part of the solder which bonds the electrode pad of the defective slider and the electrode of the suspension.

4. The method according to claim 1, wherein an opening portion is provided between a slider mounting surface of the suspension and the electrode pad of the suspension, and the solder is planarized on the electrode pad of the suspension by blowing a hot wind from the upside of the electrode pad of the suspension toward the opening portion.

5. The method according to claim 1, wherein a solder ball is supplied between the electrode pad of the new slider and the planarized solder, and the electrode pad of the new slider and the electrode pad of the suspension are bonded by melting the solder ball.

6. A method of reworking a magnetic head assembly in which an electrode pad of a magnetic head slider and an electrode pad of a suspension are soldered so as to be perpendicular to each other and in which a defective slider is replaced with a new slider when the magnetic head slider is the defective slider, the method comprising the steps of:
forming a planarized solder on the electrode pad of the suspension by heating a solder, which bonds the electrode pad of the defective slider and the electrode pad of the suspension to each other, by a hot wind with the defective slider remaining on the suspension;
removing the defective slider from the suspension;
mounting a new slider replaced for the defective slider on the suspension; and
reusing the planarized solder to bond the electrode pad of the new slider and the electrode pad of the suspension to each other.

7. The method according to claim 6, wherein during the forming of the planarized solder, a surface opposite to a slider mounting surface of the suspension is heated at a temperature lower than that of the hot wind at the same time of heat treatment by the hot wind.

8. The method according to claim 6, wherein an opening portion is provided between a slider mounting surface of the suspension and the electrode pad of the suspension, and the solder is planarized on the electrode pad of the suspension by blowing a hot wind from the upside of the electrode pad of the suspension toward the opening portion.

9. The method according to claim 6, wherein a solder ball is supplied between the electrode pad of the new slider and the planarized solder, and the electrode pad of the new slider and the electrode pad of the suspension are bonded by melting the solder ball.

10. A system to rework a magnetic head assembly in which an electrode pad of a magnetic head slider and an electrode pad of a suspension are soldered so as to be perpendicular to each other and in which a defective slider is replaced with a new slider when the magnetic head slider is the defective slider, the system comprising:
a heater to heat the suspension to a temperature effective to remove the defective slider from the suspension; and
a heat gun to planarize the solder on the electrode pad of the suspension,
wherein, to planarize the solder on the electrode pad of the suspension, the heat gun blows a hot wind from an upside of the electric pad.

11. The system according to claim 10, further comprising:
an adhesive removal tool to remove thermosetting adhesive that remains on a slider mounting surface of the suspension after the defective slider has been removed.
